(19) United States
(12) Patent Application Publication
(10) Pub. No.: US 2014/0301352 A1
(43) Pub. Date: Oct. 9, 2014

(54) ENHANCED PHYSICAL HARQ INDICATOR CHANNEL STRUCTURE

(71) Applicant: NOKIA SIEMENS NETWORKS OY, Espoo (FI)

(72) Inventors: Frank FREDERIKSEN, Klarup (DK); Lars LINDH, Helsinki (FI)

(73) Assignee: Nokia Siemens Networks OY, Espoo (FI)

(21) Appl. No.: 13/857,000

(22) Filed: Apr. 4, 2013

(51) Int. Cl. H04W 72/04

(52) U.S. Cl. CPC H04W 72/0406
USPC 370/330

(57) ABSTRACT

Various communication systems may benefit from techniques and systems for acknowledgment. For example, acknowledgements of enhanced physical downlink control channel uplink grants with enhanced physical hybrid automatic repeat request indicator channel may benefit long term evolution communication systems. A method can include preparing an enhanced physical hybrid automatic repeat request indicator channel for transmission, as a response to an uplink enhanced physical downlink control channel grant. The method can also include transmitting the enhanced physical hybrid automatic repeat request indicator channel in semi-static time and frequency resources reserved for enhanced physical downlink control channel. A predetermined number of enhanced control channel elements to be distributed over a certain number of physical resource block pairs can be configured for the transmission of the enhanced physical hybrid automatic repeat request indicator channel.

### BACKGROUND

1. Field

Various communication systems may benefit from techniques and systems for acknowledgment. For example, acknowledgements of enhanced physical downlink control channel uplink grants with enhanced physical hybrid automatic repeat request indicator channel may benefit long term evolution communication systems.

2. Description of the Related Art

Third generation partnership project (3GPP) long term evolution (LTE) has developed an enhanced physical downlink control channel (EPDCCH) for its Rel-11 standard. Compared with its predecessor, physical downlink control channel (PDCCH), EPDCCH has a primary benefit of frequency selectivity, which makes possible beamforming gain for the control channel, inter-cell interference coordination (ICIC), and interference cancellation (IC).

ICIC is a technique that can be utilized in heterogeneous networks (HetNet), where the control channels can be positioned on frequency resources, which are not used by the interfering network nodes, thereby creating possibilities for coordinating the interference levels experienced for control channels.

In the current Rel. 11 definitions, the uplink user data scheduled through EPDCCH does not have any corresponding hybrid automatic repeat request (HARQ) acknowledgement channel and it is supposed to use the legacy physical HARQ indicator channel (PHICH) channel for this purpose. PHICH does not have frequency selectivity as it is transmitted on frequency resources, which can be anywhere in the channel. However, the PHICH on the other hand offers utilization of averaging through frequency diversity as well as support for common reference symbols (CRS), which enables for low associated overhead for this channel.

In carrier aggregation (CA) cells can be configured to be scheduled from the primary cell (Pcell), whose PHICH resource also will be used for acknowledging the user equipment (UEs) in all secondary cells (Scell). The total number of needed PHICH resources can then exceed those that are available in the Pcell, even though there may be the possibility to reserve quite a lot of physical resources for the PHICH in a static manner.

One alternative to an enhanced physical HARQ indicator channel (ePHICH) is to use implicit Ack, where Nack is transmitted as adaptive UL grants. This may provide high overhead for retransmissions, but only when retransmissions are needed, and may also eat from EPDCCH resources when used. Another option may be to transmit Ack/NAck in an ePDCCH with format 3/3A. In this case, however, all ePHICHs in a group are always transmitted and there is no individual power control

### SUMMARY

According to certain embodiments, a method comprises preparing an enhanced physical hybrid automatic repeat request indicator channel for transmission, as a response to an uplink enhanced physical downlink control channel grant. The method also comprises transmitting the enhanced physical hybrid automatic repeat request indicator channel in semi-static time and frequency resources reserved for enhanced physical downlink control channel. A predetermined small number of enhanced control channel elements (eCCE) to be distributed over a certain number of physical resource block pairs are configured for the transmission of the enhanced physical hybrid automatic repeat request indicator channel.

In certain embodiments, a method comprises sending uplink grants in an enhanced physical downlink control channel. The method also comprises receiving enhanced physical hybrid automatic repeat request indicator channel in semi-static time and frequency resources reserved for enhanced physical downlink control channel. The method further comprises performing hybrid automatic repeat request processing based on the received enhanced physical hybrid automatic repeat request indicator channel.

An apparatus, in certain embodiments, comprises at least one processor and at least one memory and computer program code. The at least one memory and the computer program code are configured to, with the at least one processor, cause the apparatus at least to prepare an enhanced physical hybrid automatic repeat request indicator channel for transmission, as a response to an uplink enhanced physical downlink control channel grant. The at least one memory and the computer program code are configured to, with the at least one processor, cause the apparatus at least to transmit the enhanced physical hybrid automatic repeat request indicator channel in semi-static time and frequency resources reserved for enhanced physical downlink control channel. A predetermined number of enhanced control channel elements to be distributed over a certain number of physical resource block pairs are configured for the transmission of the enhanced physical hybrid automatic repeat request indicator channel.

An apparatus, according to certain embodiments, comprises at least one processor and at least one memory and computer program code. The at least one memory and the computer program code are configured to, with the at least one processor, cause the apparatus at least to send uplink grant for enhanced physical downlink control channel. The at least one memory and the computer program code are also configured to, with the at least one processor, cause the apparatus at least to receive enhanced physical hybrid automatic repeat request indicator channel in semi-static time and frequency resources reserved for enhanced physical downlink control channel. The at least one memory and the computer program code are further configured to, with the at least one processor, cause the apparatus at least to perform hybrid automatic repeat request processing based on the received enhanced physical hybrid automatic repeat request indicator channel.

According to certain embodiments, an apparatus comprises preparing means for preparing an enhanced physical hybrid automatic repeat request indicator channel for transmission, as a response to an uplink enhanced physical downlink control channel grant. The apparatus also comprises transmitting means for transmitting the enhanced physical hybrid automatic repeat request indicator channel in semi-static time and frequency resources reserved for enhanced physical downlink control channel. A predetermined number of enhanced control channel elements to be distributed over a certain number of physical resource block pairs are configured for the transmission of the enhanced physical hybrid automatic repeat request indicator channel.

In certain embodiments, an apparatus comprises sending means for sending uplink grant for enhanced physical downlink control channel. The apparatus also comprises receiving means for receiving enhanced physical hybrid automatic repeat request indicator channel in semi-static time and frequency resources reserved for enhanced physical downlink control channel. The apparatus further comprises processing means for performing hybrid automatic repeat request processing based on the received enhanced physical hybrid automatic repeat request indicator channel.

A non-transitory computer-readable medium is, in certain embodiments, encoded with instructions that, when executed in hardware, perform a process. The process comprises preparing an enhanced physical hybrid automatic repeat request indicator channel for transmission, as a response to an uplink enhanced physical downlink control channel grant. The process also comprises transmitting the enhanced physical hybrid automatic repeat request indicator channel in semi-static time and frequency resources reserved for enhanced physical downlink control channel. A predetermined number of enhanced control channel elements to be distributed over a certain number of physical resource block pairs are configured for the transmission of the enhanced physical hybrid automatic repeat request indicator channel.

A non-transitory computer-readable medium is, according to certain embodiments, encoded with instructions that, when executed in hardware, perform a process. The process comprises sending uplink grant for enhanced physical downlink control channel. The process also comprises receiving enhanced physical hybrid automatic repeat request indicator channel in semi-static time and frequency resources reserved for enhanced physical downlink control channel. The method further comprises performing hybrid automatic repeat request processing based on the received enhanced physical hybrid automatic repeat request indicator channel.

According certain embodiments, a computer program comprising program instructions which, when loaded into the apparatus, cause a computer system to perform methods of embodiments in any of their variations.

### BRIEF DESCRIPTION OF THE DRAWINGS

For proper understanding of the invention, reference should be made to the accompanying drawings, wherein:

FIG. 1 illustrates time resources configured for ePHICH according to certain embodiments.

FIG. 2 illustrates a method according to certain embodiments.

FIG. 3 illustrates a system according to certain embodiments.

### DETAILED DESCRIPTION

Certain embodiments provide a structure for embedding physical resources for ePHICH in enhanced control channel elements (eCCEs) that are available for the EPDCCH. This may, for example, involve reuse of existing demodulation reference symbols (DMRS) of EPDCCH.

More particularly, certain embodiments provide a method in which an ePHICH channel exists only in certain frequency resources, which are a subset of those used by ePDCCH and hence may be more compatible with ePDCCH in a HetNet environment.

LTE Rel. 11 specifies a downlink control channel that was new to Rel. 11, the enhanced downlink physical control channel (EPDCCH). The EPDCCH was not completely standardized for stand-alone operation. This lack of stand-alone operation is seen by the fact that the EPDCCH does not support a common search space, which may be important for initial access. On the other hand, the user equipment (UE) specific search space is supported by the EPDCCH. However, it may be valuable to support stand-alone operation of the EPDCCH. Thus, the supporting signaling mechanisms may need to be modified and implemented. Certain embodiments relate to at least one of these supporting signaling control channels, a channel for the uplink HARQ operation, known as the enhanced physical HARQ indicator channel (e-PHICH, ePHICH, EPHICH).

An ePHICH channel may have various goals. For example, the goals may comprise preservation of the good properties of PHICH. The goals may also comprise providing for individual PHICH operation comprising power control. Performance can be a goal as well.

Moreover, certain embodiments may aim to provide small resource reservation increments and ICIC compatibility. Certain embodiments may aim to provide robustness by using resources distributed in frequency as well as support for transmit diversity. Moreover, certain embodiments may provide simplicity and limitation by utilizing functionalities available in EPDCCH and PHICH.

In certain embodiments, ePHICH may be transmitted in time and/or frequency resources available, which are configured for ePDCCH and organized into eCCEs. One ePHICH group typically fills part of an eCCE, although approaches are permitted. For example, PHICH may be configured to be transmitted by enhanced physical hybrid automatic repeat request indicator channel groups, but the particular information, namely acknowledgements on correct reception, may not be configured to a PHICH channel; rather, the PHICH channel may actually be dynamically determined by a rule, as discussed below.

More particularly, the ePHICH can be transmitted in time/frequency resources that are in a region that is configured for ePDCCH and organized into eCCEs. One ePHICH group can fill part of a distributed eCCE. However, ePHICH can be transmitted in a different way than ePDCCH. The difference in transmission can be seen in the following comparison.

With respect to ePDCCH, the process of transmission can include error check sum (CRC) computed for the downlink control information (DCI), which is appended to the DCI. The process of transmission can also include forward error correction encoding of the DCI+CRC. The process of transmission can also further include mapping to resource elements on one or several PRB pairs. Moreover, all resources elements making up an ePDCCH can be transmitted with the same power.

By contrast, with respect to ePHICH, ePHICH channels (Ack/Nack) can be organized in groups (typically 4 channels/group) and groups can bee repeated on a number of PRB pairs. Moreover, the process can include mapping to resource elements on one or several PRB pairs. Furthermore, different ePHICH channels inside a ePHICH group can have different power. Nevertheless, in ePHICH no error detection and no forward error correction may be applied.

In certain embodiments, EPDCCH can be formed by 1, 2, 4, 8, 16 or 32 Enhanced Control Channel Elements (eCCEs), as defined in 3GPP TS 36.211 6.8A, which is hereby incorporated by reference in its entirety. The number of eCCEs may depend on the configuration, subframe type, and/or presence of other signals. The eCCEs may exist only in certain physical resource block (PRB) pairs given by configuration for each UE. Specifically, they may exist in 12 subcarriers in all orthogonal frequency division multiplexed (OFDM) symbols in a subframe, which in the context of LTE can be 1 ms. The number of eCCEs in a PRB pair can be 2 or 4, but in a typical case may be 4.

In certain embodiments, a small number of eCCEs distributed over a certain number of PRB pairs can be configured for ePHICH. In a typical case 2 eCCEs distributed over 4 PRB pairs may be used for ePHICH.

For a UE to use ePHICH, it is not necessary that the UE be configured to these same PRB pairs.

In certain embodiments, ePHICH can share at least one same reference signal with the ePDCCHs, which are present in the same PRB pair. When there is no EPDCCH in a configured PRB pair, the ePHICH can use the reference signals without restrictions.

The ePHICH itself may not be transmitted in an ePDCCH. In certain embodiments the ePHICH can be transmitted in terms of ePHICH groups, which are mapped to resource elements (REs) in the reserved eCCEs. The ePHICHs can be transmitted in a group, which is hereby incorporated herein by reference in its entirety. In this procedure, ePHICH binary phase shift keying (BPSK) modulated symbol pairs can be scrambled and summed. The resulting sum can be then repeated on each configured PRB pair and transmitted with a similar transmit diversity scheme that is used in EPDCCH. An advantage of this procedure is robustness and individual power control for the ePHICHs. As the transmit diversity for ePDCCH can be based on pairs of REs, which can accommodate two or four ePHICHs in an ePHICH group. The REs in the ePHICH group can be repeated on all PRB pairs configured for ePHICH.

In some embodiments of the invention, where the number of PRB pairs are very small, for example two, repetition can also take place partially inside the eCCE. This will reduce the number of ePHICH groups but increase the robustness in a small ePHICH configuration.

In some other embodiments of the invention, the ePHICH can be transmitted in only one PRB pair, which we refer to as localized ePHICH, which can take advantage of the precoding gain. In that case the repetition takes place only inside the single PRB pair. Localized ePHICH can be envisioned in the case when, for example, the uplink (UL) grant is transmitted with a localized ePDCCH.

The number of ePHICHs that can be accommodated in one eCCE can depend on how many REs there are in an eCCE. The number of Res can depend on the presence of other signals as well as on the subframe type. The maximum number of ePHICHs that there can be in two eCCEs may be 18, corresponding to 9 ePHICH groups, while in a typical case there may be 12, corresponding to 6 ePHICH groups

There can be a mapping similar to what exists for PHICH, as described at 3GPP TS 36.213 9.1.2, which is hereby incorporated herein by reference in its entirety. The mapping may be between the first PRB in the uplink (UL) allocation, the DMRS field in the UL grant, and/or optionally other fields like the carrier indicator field (CIF) for carrier aggregation to the actual PHICH number.

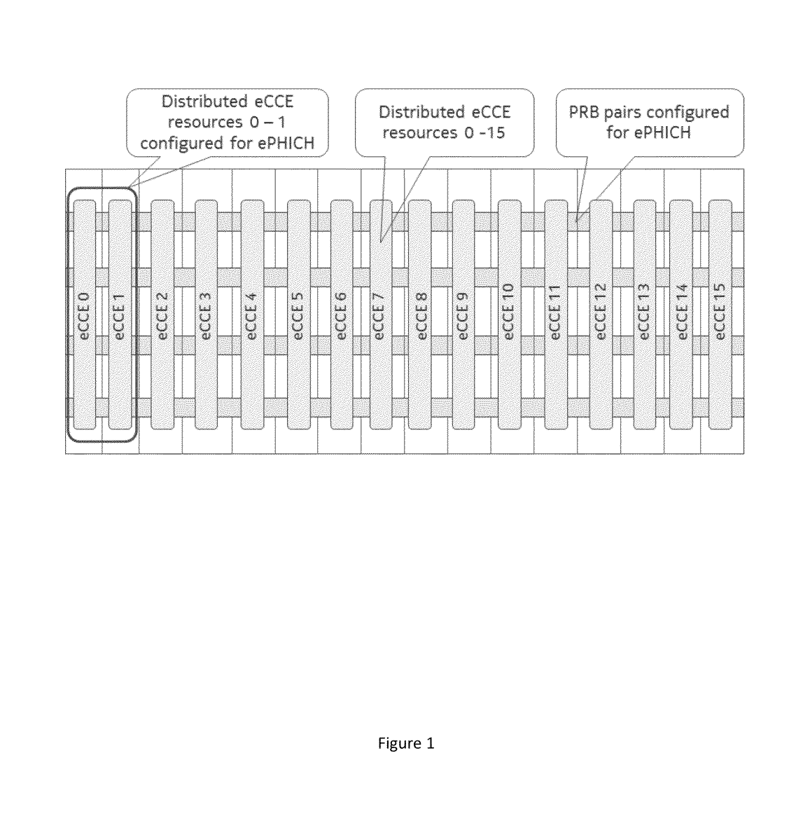

In certain embodiments, more than 2 PHICH channels are joined for the creation of a PHICH group. This approach may be used if, for example, more physical resources are allocated to the same PHICH group. According to certain embodiments, ePHICH can be transmitted in semi-static time/frequency resources that are reserved for EPDCCH as shown in FIG. 1. The PRB pairs as well as the eCCEs for ePHICH are configured in UE specific way.

FIG. 1 illustrates time resources configured for ePHICH according to certain embodiments.

As shown in FIG. 1, there may be 2 eCCEs and four PRB pairs in an ePHICH configuration. Thus, in a typical case there may be 6 ePHICH groups corresponding to 12 individual ePHICHs, with 9 ePHICH groups and 18 ePHICHs in a maximum case. The number of PRB pairs used may not affect the number of ePHICH groups. Instead, the number of PRB pairs may affect the robustness of the transmission. When the eCCE is smaller than 24 REs, then the number of ePHICHs may correspondingly be smaller.

Moreover, as shown in FIG. 1, distributed eCCE resources 0-1 can be configured for ePHICH. Indeed, through distributed eCCE resources 0-10, PRB pairs can be configured for ePHICH.

Certain embodiments may provide various advantages or benefits. For example, certain embodiments may provide frequency selective resource configuration compliant with ICIC usage. Moreover, certain embodiments may provide shared functionalities and compatibility with existing channels. Furthermore, certain embodiments provide robust operation with frequency distributed resources and transmit diversity.

Furthermore, certain embodiments provide individual power control for the different ePHICH channels. Moreover, certain embodiments can provide flexibility in configuring resources for ePHICH, for example, by providing small resource reservation increments.

Certain embodiments may increase of the acknowledgement (Ack)/negative acknowledgment (Nack) capacity for uplink user data. Unused eCCEs can, in certain embodiments, be configured for ePHICH can be reused for ePDCCH. Moreover, certain embodiments are backwards compatible with Rel-11 UEs.

For Rel-11 UEs, the configured ePHICH resources may block some candidates in the user specific search space. On the contrary, for Rel-12 UEs the search space can be defined to map around the configured ePHICH resources and hence ePDCCH candidates do not need to be blocked.

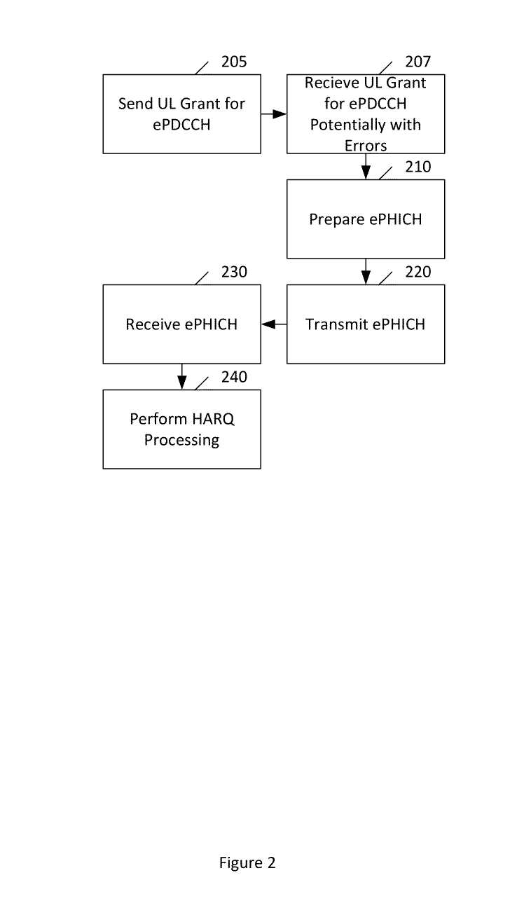

FIG. 2 illustrates a method according to certain embodiments. As shown in FIG. 2, a method can comprise at 205, sending an uplink grant for an enhanced physical downlink control channel. The method can comprise, at 210, preparing an enhanced physical hybrid automatic repeat request indicator channel for transmission, as a response to an uplink enhanced physical downlink control channel grant. This can be based on receiving the uplink grant either partly, completely, or erroneously, at 207.

The method can also comprise, at 220, transmitting the enhanced physical hybrid automatic repeat request indicator channel in semi-static time and frequency resources reserved for enhanced physical downlink control channel. A predetermined number of enhanced control channel elements to be distributed over a certain number of physical resource block pairs can be configured for the transmission of the enhanced physical hybrid automatic repeat request indicator channel.

The method can further comprise, at 230, receiving enhanced physical hybrid automatic repeat request indicator channel in semi-static time and frequency resources reserved for enhanced physical downlink control channel. The method can additionally comprise, at 240, performing hybrid automatic repeat request processing based on the received enhanced physical hybrid automatic repeat request indicator channel.

The enhanced physical hybrid automatic repeat request indicator channel can share at least one same reference signal with the enhanced physical downlink control channels present in the same physical resource block pair. Moreover, when a physical resource block pair is configured for but not actually containing any enhanced physical downlink control channel, no restriction for the usage of reference signals are set.

The enhanced physical hybrid automatic repeat request indicator channel can be transmitted by enhanced physical hybrid automatic repeat request indicator channel groups. The groups can be mapped to resource elements in reserved enhanced control channel elements.

A plurality of enhanced physical hybrid automatic repeat request indicator channels comprising the enhanced physical hybrid automatic repeat request indicator channel can be transmitted in a group. The group can comprise four or more enhanced physical hybrid automatic repeat request indicator channels. Resource elements in the enhanced physical hybrid automatic repeat request indicator channel group can be repeated on all physical resource block pairs configured for enhanced physical hybrid automatic repeat request indicator channel.

The number of physical resource block pairs can be two and repetition can take place partially inside the enhanced control channel element. The enhanced physical hybrid automatic repeat request indicator channel can be transmitted in, for example, only one physical resource block pair. In this case, repetition of the enhanced physical hybrid automatic repeat request indicator channel can take place only inside the one physical resource block pair.

Physical resource block pairs as well as enhanced control channel elements for enhanced physical hybrid automatic repeat request indicator channel can be configured in a user equipment specific way or user device specific way.

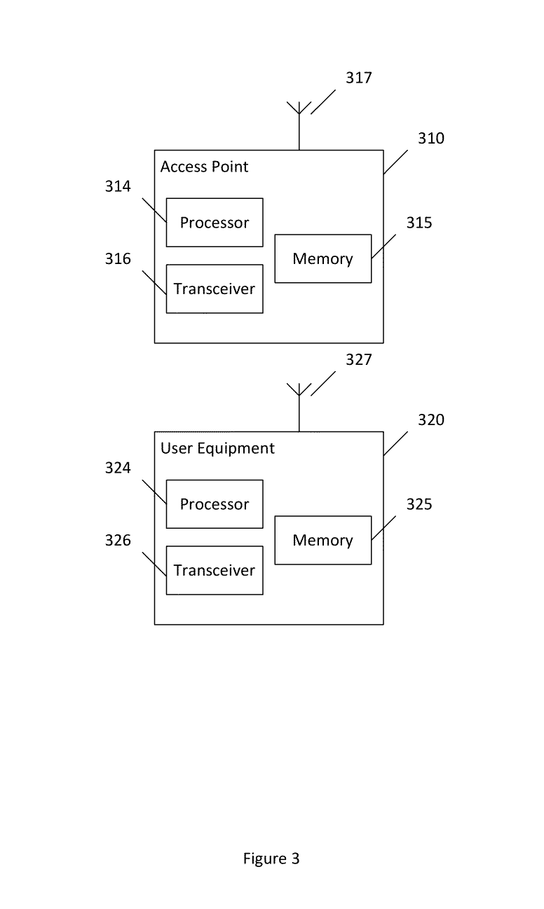

FIG. 3 illustrates a system according to certain embodiments of the invention. It should be understood that each block of the flowchart of FIG. 2 and any combination thereof may be implemented by various means or their combinations, such as hardware, software, firmware, one or more processors and/or circuitry. In one embodiment, a system may comprise several devices, such as, for example, access point 310 and UE or user device 320. The system may comprise more than one UE 320 and more than one access point 310, although only one of each is shown for the purposes of illustration. The system may also involve only at least two UEs 320 or only at least two access points 310. An access point can be a base station, eNode B (eNB), host, server, or other network access element. Each of these devices may comprise at least one processor, control unit, or module, respectively indicated as 314 and 324. At least one memory may be provided in each device, and indicated as 315 and 325, respectively. The memory may comprise computer program instructions or computer code contained therein. One or more transceiver 316 and 326 may be provided, and each device may also comprise an antenna, respectively illustrated as 317 and 327. Although only one antenna each is shown, many antennas and multiple antenna elements may be provided to each of the devices. Other configurations of these devices, for example, may be provided. For example, access point 310 and UE 320 may be additionally configured for wired communication, in addition to wireless communication, and in such a case antennas 317 and 327 may illustrate any form of communication hardware, without being limited to merely an antenna.

Transceivers 316 and 326 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example.

It should also be appreciated that according to the “liquid” or flexible radio concept, the operations and functionalities may be performed in different entities, such as nodes, hosts or servers, in a flexible manner. In other words, “division of labour” may vary case by case. One possible use is to make a network element to deliver local content. One or more functionalities may also be implemented as a virtual application that is as software that can run on a server.

A user device or user equipment may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations of thereof.

In an exemplary embodiment, an apparatus, such as a node, may comprise means for carrying out embodiments described above in relation to FIG. 2. In an exemplary embodiment, an apparatus may comprise means (314) for preparing an enhanced physical hybrid automatic repeat request indicator channel for transmission, as a response to an uplink enhanced physical downlink control channel grant. Likewise, another apparatus may comprise means (324) for performing hybrid automatic repeat request processing based on the received enhanced physical hybrid automatic repeat request indicator channel.

Processors 314 and 324 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. For firmware or software, the implementation may comprise modules or unit of at least one chip set (e.g., procedures, functions, and so on).

Memories 315 and 325 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as access point 310 and/or UE 320, to perform any of the processes described above (see, for example, FIG. 2). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 3 illustrates a system comprising an access point 310 and a UE 320, embodiments of the invention may be applicable to other configurations, and configurations involving additional elements, as illustrated and discussed herein. For example, multiple user equipment devices and multiple access points may be present, or other nodes providing similar functionality, such as relay nodes that may receive data from an access point and forward the data to a UE and may implement both functionality of the UE and functionality of the access point.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

3GPP Third Generation Partnership Project

LTE Long Term Evolution

EPDCCH Enhanced Physical Downlink Control Channel

PDCCH Physical Downlink Control Channel

ICIC Inter-Cell Interference Coordination

IC Interference Cancellation

HetNet Heterogeneous Network

HARQ Hybrid Automatic Repeat Request

PHICH Physical HARQ Indicator Channel

ePHICH Enhanced Physical HARQ Indicator Channel

CA Carrier Aggregation

Pcell Primary Cell

Scell Secondary Cell

UE User Equipment

DMRS Demodulation Reference Symbol

eCCE Enhanced Control Channel Element

PRB Physical Resource Block

OFDM Orthogonal Frequency Division Multiplexed

RE Resource Element

BPSK Binary Phase Shift Keying

UL Uplink

CIF Carrier Indicator Field

Ack Acknowledgement

Nack Negative Acknowledgment

We claim:

1. A method, comprising:
preparing an enhanced physical hybrid automatic repeat request indicator channel for transmission, as a response to an uplink enhanced physical downlink control channel grant; and
transmitting the enhanced physical hybrid automatic repeat request indicator channel in semi-static time and frequency resources reserved for enhanced physical downlink control channel,
wherein a predetermined number of enhanced control channel elements to be distributed over a certain number of physical resource block pairs are configured for the transmission of the enhanced physical hybrid automatic repeat request indicator channel.

2. The method of claim 1, wherein the enhanced physical hybrid automatic repeat request indicator channel shares at least one same reference signal with the enhanced physical downlink control channels present in the same physical resource block pair.

3. The method of claim 1, wherein when a physical resource block pair is configured for but not actually containing any enhanced physical downlink control channel, no restrictions for the usage of reference signals are set.

4. The method of claim 1, wherein the enhanced physical hybrid automatic repeat request indicator channel is configured to be transmitted by enhanced physical hybrid automatic repeat request indicator channel groups, wherein the groups are mapped to resource elements in reserved enhanced control channel elements.

5. The method of claim 1, wherein a plurality of enhanced physical hybrid automatic repeat request indicator channels comprising the enhanced physical hybrid automatic repeat request indicator channel are configured to be transmitted in a group.

6. The method of claim 5, wherein the group comprises two or more enhanced physical hybrid automatic repeat request indicator channels.

7. The method of claim 5, wherein resource elements in the enhanced physical hybrid automatic repeat request indicator channel group are configured to be repeated on all or at least two physical resource block pairs configured for enhanced physical hybrid automatic repeat request indicator channel.

8. The method of claim 1, wherein the number of physical resource block pairs is two and repetition takes place partially inside the enhanced control channel element.

9. The method of claim 1, wherein the enhanced physical hybrid automatic repeat request indicator channel is configured to be transmitted in only one physical resource block pair.

10. The method of claim 9, wherein repetition of the enhanced physical hybrid automatic repeat request indicator channel takes place only inside the one physical resource block pair.

11. The method of claim 1, wherein physical resource block pairs as well as enhanced control channel elements for enhanced physical hybrid automatic repeat request indicator channel are configured in a user device specific way.

12. A method, comprising:
sending uplink grant for enhanced physical downlink control channel;
receiving enhanced physical hybrid automatic repeat request indicator channel in semi-static time and frequency resources reserved for enhanced physical downlink control channel; and
performing hybrid automatic repeat request processing based on the received enhanced physical hybrid automatic repeat request indicator channel.

13. An apparatus, comprising:
at least one processor; and
at least one memory and computer program code,
wherein the at least one memory and the computer program code are configured to, with the at least one processor, cause the apparatus at least to
prepare an enhanced physical hybrid automatic repeat request indicator channel for transmission, as a response to an uplink enhanced physical downlink control channel grant; and
transmit the enhanced physical hybrid automatic repeat request indicator channel in semi-static time and frequency resources reserved for enhanced physical downlink control channel,
wherein a predetermined number of enhanced control channel elements to be distributed over a certain number of physical resource block pairs are configured for the transmission of the enhanced physical hybrid automatic repeat request indicator channel.

14. The apparatus of claim 13, wherein the enhanced physical hybrid automatic repeat request indicator channel shares at least one same reference signal with the enhanced physical downlink control channels present in the same physical resource block pair.

15. The apparatus of claim 13, wherein when a physical resource block pair configured for but not actually containing any enhanced physical downlink control channel, no restriction for the usage of reference signals are set.

16. The apparatus of claim 13, wherein the enhanced physical hybrid automatic repeat request indicator channel is configured to be transmitted by enhanced physical hybrid automatic repeat request indicator channel groups, wherein the groups are mapped to resource elements in reserved enhanced control channel elements.

17. The apparatus of claim 13, wherein a plurality of enhanced physical hybrid automatic repeat request indicator channels comprising the enhanced physical hybrid automatic repeat request indicator channel are configured to be transmitted in a group.

18. The apparatus of claim 17, wherein the group comprises two or more enhanced physical hybrid automatic repeat request indicator channels.

19. The apparatus of claim 17, wherein resource elements in the enhanced physical hybrid automatic repeat request indicator channel group are configured to be repeated on all or at least on two physical resource block pairs configured for enhanced physical hybrid automatic repeat request indicator channel.

20. The apparatus of claim 13, wherein the number of physical resource block pairs is two and repetition takes place partially inside the enhanced control channel element.

21. The apparatus of claim 13, wherein the enhanced physical hybrid automatic repeat request indicator channel is configured to be transmitted in only one physical resource block pair.

22. The apparatus of claim 21, wherein repetition of the enhanced physical hybrid automatic repeat request indicator channel takes place only inside the one physical resource block pair.

23. The apparatus of claim 13, wherein physical resource block pairs as well as enhanced control channel elements for enhanced physical hybrid automatic repeat request indicator channel are configured in a user device specific way.

24. An apparatus, comprising:
at least one processor; and
at least one memory and computer program code,
wherein the at least one memory and the computer program code are configured to, with the at least one processor, cause the apparatus at least to
send uplink grant for enhanced physical downlink control channel;
receive enhanced physical hybrid automatic repeat request indicator channel in semi-static time and frequency resources reserved for enhanced physical downlink control channel; and
perform hybrid automatic repeat request processing based on the received enhanced physical hybrid automatic repeat request indicator channel.
